(19) United States
(12) Patent Application Publication
(10) Pub. No.: US 2026/0312098 A1
(43) Pub. Date: Oct. 8, 2026

(54) DIAGNOSIS METHOD FOR DETERMINING A STATE OF A FUEL CELL SYSTEM

(71) Applicant: Robert Bosch GmbH, Stuttgart (DE)

(72) Inventors: Helerson Kemmer, Vaihingen (DE); Leonie Sophie Moeller, Stuttgart (DE)

(21) Appl. No.: 19/482,066

(22) PCT Filed: May 7, 2024
(86) PCT No.: PCT/EP2024/062524

§ 371 Date: Nov. 6, 2025

(30) Foreign Application Priority Data
May 19, 2023 (DE) 10 2023 204 701.2

(51) Int. Cl. H01M 8/04992; H01M 8/04223; H01M 8/04298; H01M 8/0444

(52) U.S. Cl. CPC H01M 8/04992; H01M 8/04231; H01M 8/04305; H01M 8/04447; H01M 8/04462

(57) ABSTRACT

The present invention relates to a diagnosis method (100) for determining a state of a fuel cell system (400), wherein the diagnosis method (100) comprises:
training (101) a machine learner at a first point in time such that it determines at least one output gas concentration in an anode subsystem (403) of the fuel cell system (400) on the basis of at least one input gas concentration measured in a measuring line (411) of a fuel cell system (400),
re-training (103) the machine learner at a second point in time such that it determines at least one output gas concentration in the anode subsystem (403) of the fuel cell system (400) on the basis of at least one input gas concentration measured in the measuring line (411) of the fuel cell system (400),
determining a nitrogen permeability of fuel cells of the fuel cell system (400) on the basis of a change in the machine learner between the first point in time and the second point in time.

### BACKGROUND

The invention relates to a diagnosis method for determining a state of a fuel cell system, a fuel cell system and a software product according to the disclosure.

Nitrogen permeability, i.e., the ability for nitrogen to pass through, changes over time for fuel cells or their membranes. In particular, older fuel cells demonstrate higher nitrogen permeability than younger or new fuel cells.

If the nitrogen permeability of a fuel cell is too high, then more thorough, i.e., longer or more frequent, purge processes are required. This leads to significantly higher hydrogen consumption compared to a new state.

Therefore, observing the nitrogen permeability of respective fuel cells is advantageous in order to plan for a possible necessary replacement or maintenance of a fuel cell stack.

Furthermore, with known nitrogen permeability, condition-dependent measures may be taken to protect the membranes and maximize the lifespan of the respective fuel cell stack.

### SUMMARY

Features and details described in connection with the diagnosis method according to the invention naturally also apply in connection with the fuel cell system according to the invention or the software product according to the invention and vice versa, so that mutual reference can always be made to the disclosure of the individual aspects of the invention.

The proposed invention serves in particular to determine a change in nitrogen permeability of fuel cells of a fuel cell system.

Therefore, according to a first aspect of the invention, a diagnosis method for determine a state of a fuel cell system is presented. The diagnosis method comprises training a machine learner at a first point in time such that it determines at least one output gas concentration in an anode subsystem of the fuel cell system on the basis of at least one input gas concentration measured in a measuring line of a fuel cell system, re-training the machine learner at a second point in time such that it determines at least one output gas concentration in the anode subsystem of the fuel cell system on the basis of at least one input gas concentration measured in the measuring line of the fuel cell system, and determining a nitrogen permeability of fuel cells of the fuel cell system on the basis of a change in the machine learner between the first point in time and the second point in time.

In the context of the proposed invention, a machine learner should be understood to mean a mathematical model that associates a measured, i.e., determined by a sensor, input concentration with an output concentration. For example, a machine learner may include an artificial neural network and/or a Gaussian process model, particularly having a NARX structure.

In particular, the machine learner may be used to set a purge process for purging the fuel cell system, i.e., to adjust purge times or purge intervals to a respective determined output concentration. Accordingly, a “virtual mass spectrometer” may be provided by the machine learner that determines a gas concentration, particularly a nitrogen concentration and/or a hydrogen concentration in the anode subsystem of the fuel cell system.

The presented diagnosis method is based on multiple or repeated training of the machine learner provided according to the invention. For this purpose, the machine learner is trained at a first point in time, e.g., at the delivery point and re-trained later, at a second point in time, e.g., during maintenance or inspection.

Since the physical properties, in particular the nitrogen permeability of fuel cells of the fuel cell system, change over time, the re-training at the second point in time leads to a change in the machine learner or a mathematical model upon which the machine learner is based. Accordingly, the second machine learner or the machine learner trained at the second point in time associates different values or output concentrations with the respective input concentrations than the first machine learner or the machine learner trained at the first point in time.

Accordingly, the first machine learner associates respective input gas concentrations with first output gas concentrations and the second machine learner associates the respective input gas concentrations with second output gas concentrations.

The second machine learner is an altered version of the first machine learner. To this end, the first machine learner may be altered or a new machine learner based on the first machine learner or a copy of the first machine learner may be used and adjusted accordingly by the training at the second point in time. Accordingly, it is conceivable that the first machine learner and the second machine learner operate in parallel to determine, for example, a difference between the outputs of the respective machine learners.

The invention presented is based on the principle that the change in the machine learner from the first point in time to the second point in time or the change between the first machine learner and the second machine learner is associated with a nitrogen permeability, in particular a characteristic value that quantifies a nitrogen permeability.

It is conceivable that the change in the machine learner is determined based on a deviation between a first output concentration determined by the machine learner trained at the first point in time and a second output concentration determined by the machine learner trained at the second point in time.

A difference in the state of the fuel cell system between the first point in time and the second point in time causes a difference between first output gas concentrations determined by the first machine learner and second output gas concentrations determined by the second machine learner. Accordingly, based on the difference between the first output gas concentrations and the second output gas concentrations, the state of the fuel cell system, in particular a nitrogen permeability, can be inferred. For this purpose, for example, a mapping scheme may be used that associates a value of a nitrogen permeability with a respective difference between first output gas concentrations and second output gas concentrations. This mapping scheme may be, for example, another machine learner that was trained on various training fuel cell systems exhibiting various nitrogen permeabilities. Of course, the training fuel cell systems can be designed in real or simulated fashion.

It is further conceivable that a control parameter for a purge valve of the fuel cell system is selected as a function of a respective output concentration determined by the machine learner, and the change in the machine learner is determined based on a deviation between a first control parameter determined as a function of the machine learner trained at the first point in time and a second control parameter determined as a function of the machine learner trained at the point in second point in time.

By indirectly determining a change in the machine learner and, thereby, the state of the fuel cell system via a control parameter selected as a function of an output gas concentration of the machine learner, a control loop implemented in the fuel cell system may be used to infer nitrogen permeability of the fuel cells of the fuel cell system. For this purpose, a time between two purge processes or a purge interval can be evaluated as control parameters, for example. Accordingly, a characteristic value for quantifying nitrogen permeability may be directly associated with a change in the control parameter after the second point in time. For this purpose, for example, a mapping scheme may be used that associates a value of a nitrogen permeability with a respective difference between a first control parameter determined as a function of the first machine learner and a second control parameter determined as a function of the second machine learner. This mapping scheme may be, for example, another machine learner that was trained on various training fuel cell systems exhibiting various nitrogen permeabilities. Of course, the training fuel cell systems can be designed in real or simulated fashion.

It is further conceivable that the change in the machine learner is determined based on a deviation between a first model parameter of a mathematical model of the machine learner trained at the first point in time and a second model parameter of a mathematical model of the machine learner trained at the second point in time.

A change of the machine learner from the first point in time to the second point in time, in particular, requires a change in model parameters, such as a weighting of regression parameters of a Gaussian process of the machine learner, for example. Accordingly, based on a difference between respective model parameters of the first machine learner and respective model parameters of the second machine learner, a characteristic value for quantifying the nitrogen permeability can be associated. For this purpose, for example, a mapping scheme may be used that associates a value of nitrogen permeability with a respective difference between a first model parameter of the first machine learner and a second model parameter of the second machine learner. This mapping scheme may be, for example, another machine learner that was trained on various training fuel cell systems exhibiting various nitrogen permeabilities. Of course, the training fuel cell systems can be designed in real or simulated fashion.

It is further conceivable that the machine learner is trained based on a ground truth, at least at the second point in time, determined by a gas concentration sensor located on the anode subsystem of the fuel cell system.

A gas concentration sensor located on the anode subsystem of the fuel cell system, such as a hydrogen concentration sensor and/or a nitrogen concentration sensor, determines real values representing actual physical conditions in a particular fuel cell system, that is, a respective nitrogen permeability.

Accordingly, the machine learner is trained with a ground truth representing the actual physical conditions or the training comprises adaptation of the machine learner to the actual physical conditions, such that the input gas parameters are associated with the output gas parameters while incorporating the actual physical conditions, and the actual physical conditions can be inferred based on the association accordingly.

It is particularly conceivable that the output concentration comprises a concentration of hydrogen and/or nitrogen.

It is further conceivable that the fuel cell system is adjusted as a function of the determined nitrogen permeability.

By adjusting the fuel cell system as a function of the determined nitrogen permeability, for example, the fuel cell system can be adapted to the current nitrogen permeability.

It is further conceivable that the determined nitrogen permeability is output on a display and/or stored in a memory.

Based on a nitrogen permeability output on a display, which can be output as a quantitative value or as a traffic light pattern, for example, a state of the fuel cell system can be presented to a user. A recommended maintenance interval, for example, can be determined dynamically as a function of the nitrogen permeability.

Based on a nitrogen permeability stored in a memory, subsequent processes, such as a control process for the fuel cell system, can access the nitrogen permeability or its value and dynamically adapt to the nitrogen permeability accordingly.

It is further conceivable that the machine learner is trained using a training fuel cell system at the first point in time.

By means of a training fuel cell system, for example an identical reference system or a simulated fuel cell system, a fuel cell system in the state at time of delivery can be validly mapped or simulated so that operation of a respective fuel cell system in the state at time of delivery for training purposes can be omitted.

According to a second aspect, the invention presented here relates to a fuel cell system for converting energy.

The fuel cell system presented comprises a fuel cell stack comprising an anode subsystem and a cathode subsystem, an exhaust line, a purge line, a measuring line located in the direction of flow after a connection of a purge line (409) and exhaust line (407), and a computing unit. The computing unit is configured to perform a possible configuration of the presented diagnosis method.

According to a third aspect, the invention presented relates to a software product comprising instructions that, when executed by a computing unit, configure the computing unit to perform a possible embodiment of the presented diagnosis method.

Advantages described in detail in the diagnosis method for determining a state of a fuel cell system according to the first aspect of the invention apply equally to the fuel cell system for converting energy according to the second aspect of the invention as well as to the software product according to the third aspect of the invention.

Further advantages, features, and details of the invention arise from the following description, in which exemplary embodiments of the invention are described in detail with reference to the drawings.

### BRIEF DESCRIPTION OF THE DRAWINGS

Shown are:

FIG. 1 a possible embodiment of the presented diagnosis method,

FIG. 2 a change in output gas concentration values caused by a change in a machine learner through re-training,

FIG. 3 a change in control parameters of a purge operation caused by a change in a machine learner through re-training,

FIG. 4 one possible embodiment of the fuel cell system presented,

### DETAILED DESCRIPTION

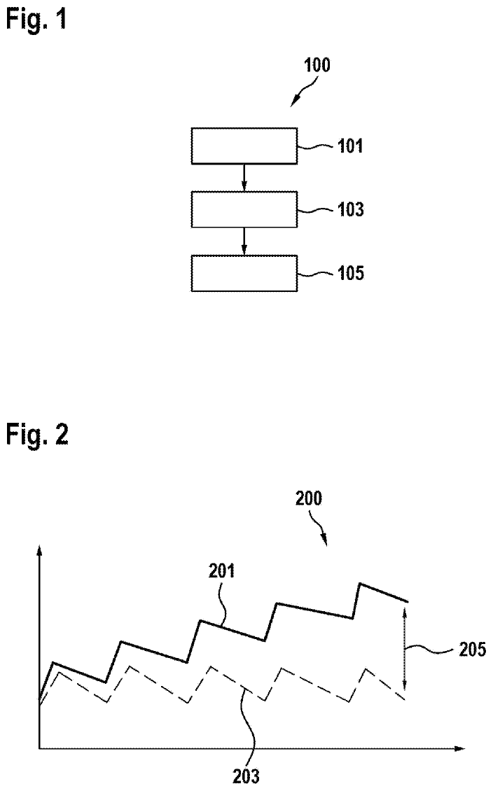

FIG. 1 shows a diagnosis method 100 for determining a state of a fuel cell system.

Diagnosis method 100 comprises a first training step 101, in which a machine learner is trained at a first point in time such that it determines at least one output gas concentration in an anode subsystem of the fuel cell system, on the basis of at least one input gas concentration measured in a measuring line of a fuel cell system, such as a training fuel cell system, for example.

Furthermore, the diagnosis method 100 comprises a second training step 103, in which the machine learner previously trained in the first training step 101 is trained at a second point in time such that it determines at least one output gas concentration in the anode subsystem of the fuel cell system based on at least one input gas concentration measured in the measuring line of a respective fuel cell system.

Furthermore, the diagnosis method 100 comprises a determination step 105, in which a nitrogen permeability of fuel cells of the fuel cell system is determined on the basis of a change in the machine learner between the first point in time and the second point in time.

FIG. 2 shows a graph 200 with time on the x-axis and output gas concentration, for example nitrogen or hydrogen, on the y-axis.

A first path 201 corresponds to output gas concentration values determined by a machine learner trained at a first point in time.

A second path 203 corresponds to output gas concentration values determined by the machine learner trained at a second point in time.

Based on a deviation between the first path 201 and the second path 203 as indicated by arrow 205, a change in the fuel cell system, in particular a nitrogen permeability of respective fuel cells of the fuel cell system, can be concluded.

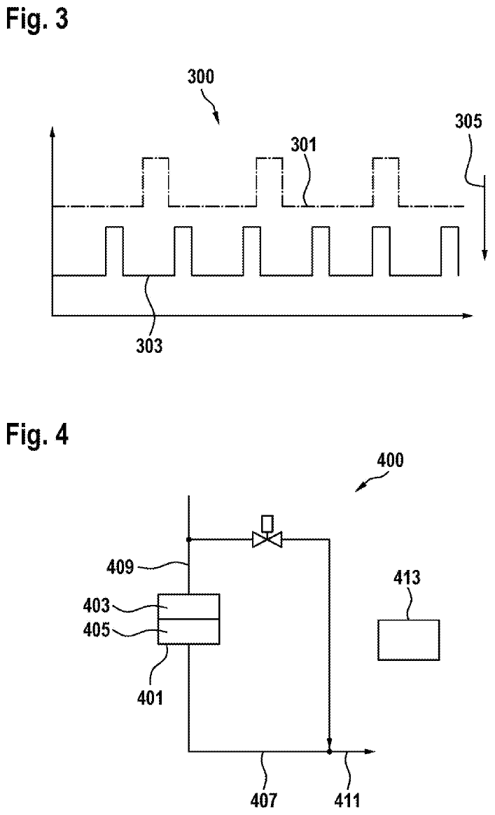

FIG. 3 shows a graph 300 with the time on the x-axis and activity of a purge valve of a fuel system on the y-axis.

A first path 301 corresponds to an activity of the purge valve that has been adjusted or regulated as a function of a machine learner trained at a first point in time.

A second path 303 corresponds to an activity of the purge valve that has been adjusted or regulated as a function of the machine learner trained at a second point in time.

Based on a deviation between the first path 301 and the second path 303 as indicated by arrow 305, a change in the fuel cell system, in particular a nitrogen permeability of respective fuel cells of the fuel cell system, can be concluded.

FIG. 4 shows a fuel cell system 400 for converting energy. The fuel cell system 400 comprises a fuel cell stack 401 comprising an anode subsystem 403 and a cathode subsystem 405, an exhaust line 407, a purge line 409, a measurement line 411 located in the direction of flow after a connection of a purge line (409) and exhaust line (407), and a computing unit 413.

The computing unit 413 is configured to perform the diagnosis method 100 according to FIG. 1.

1. A diagnosis method (100) for determining a state of a fuel cell system (400), wherein the diagnosis method (100) comprises:
training (101) a machine learner at a first point in time such that it determines output gas concentration in an anode subsystem of the fuel cell system based on an input gas concentration measured in a measuring line of a fuel cell system,
re-training (103) the machine learner at a second point in time such that it determines output gas concentration in the anode subsystem (403) of the fuel cell system (400) based on an input gas concentration measured in the measuring line (411) of the fuel cell system (400),
determining a nitrogen permeability (105) of fuel cells of the fuel cell system (400) on a change in the machine learner between the first point in time and the second point in time, and
adjusting the fuel cell system (400) as a function of the determined nitrogen permeability.

2. The diagnosis method (100) according to claim 1, wherein the change in the machine learner is determined based on a deviation between a first output concentration determined by the machine learner trained at the first point in time and a second output concentration determined by the machine learner trained at the second point in time.

3. The diagnosis method (100) according to claim 1, wherein
a control parameter for a purge valve of the fuel cell system (400) is selected as a function of a respective output concentration determined by the machine learner, and
the change in the machine learner is determined based on a deviation between a first control parameter determined as a function of the machine learner trained at the first point in time and a second control parameter determined as a function of the machine learner trained at the second point in time.

4. The diagnosis method (100) according to claim 1, wherein the change in the machine learner is determined based on a deviation between a first model parameter of a mathematical model of the machine learner trained at the first point in time and a second model parameter of a mathematical model of the machine learner trained at the second point in time.

5. The diagnosis method (100) according to claim 1, wherein the machine learner is trained based on a ground truth, at least at the second point in time, determined by a gas concentration sensor located on the anode subsystem (403) of the fuel cell system (400).

6. The diagnosis method (100) according to claim 1, wherein the output concentration comprises a concentration of hydrogen and/or nitrogen.

7. (canceled)

8. The diagnosis method (100) according to claim 1, wherein the determined nitrogen permeability is output on a display and/or stored in a memory.

9. The diagnosis method (100) according to claim 1, wherein the machine learner is trained using a training fuel cell system at the first point in time.

10. A fuel cell system (400) for converting energy, wherein the fuel cell system (400) comprises:
a fuel cell stack (401) which comprises an anode subsystem (403) and a cathode subsystem (405),
an exhaust line (407),
a purge line (409),
a measuring line (411) located in a direction of flow after a connection of the purge line (409) and the exhaust line (407),
a computer (413), configured to
train (101) a machine learner at a first point in time such that it determines an output gas concentration in an anode subsystem of the fuel cell system based on an input gas concentration measured in a measuring line of a fuel cell system,
re-train (103) the machine learner at a second point in time such that it determines a output gas concentration in the anode subsystem (403) of the fuel cell system (400) based on an input gas concentration measured in the measuring line (411) of the fuel cell system (400),
determine a nitrogen permeability (105) of fuel cells of the fuel cell system (400) based on a change in the machine learner between the first point in time and the second point in time, and
adjust the fuel cell system (400) as a function of the determined nitrogen permeability.

11. A non-transitory, computer-readable medium comprising instructions that, when executed by a computer (413), cause the computer (413) to
train (101) a machine learner at a first point in time such that it determines an output gas concentration in an anode subsystem of a fuel cell system based on an input gas concentration measured in a measuring line of a fuel cell system,
re-train (103) the machine learner at a second point in time such that it determines a output gas concentration in the anode subsystem (403) of the fuel cell system (400) based on an input gas concentration measured in the measuring line (411) of the fuel cell system (400),
determine a nitrogen permeability (105) of fuel cells of the fuel cell system (400) based on a change in the machine learner between the first point in time and the second point in time, and
adjust the fuel cell system (400) as a function of the determined nitrogen permeability.
